(19) United States
(12) Patent Application Publication
(10) Pub. No.: US 2009/0202936 A1
(43) Pub. Date: Aug. 13, 2009

(54) HEAT REGULATED PRINTER ELEMENT, USE OF A RUBBER MATERIAL HAVING A PHASE CHANGE MATERIAL DISPERSED THEREIN, A PRINTER AND A METHOD OF PRINTING

(76) Inventor: Herbert MORELISSEN, ST TEGELEN (NL)

Correspondence Address: BIRCH STEWART KOLASCH & BIRCH, PO BOX 747, FALLS CHURCH, VA, 22040-0747, US

(21) Appl. No.: 12/366,375

(22) Filed: Feb. 5, 2009

(30) Foreign Application Priority Data
Feb. 7, 2008 (EP) 08151162.8

(51) Int. Cl. G03G 13/20

(52) U.S. Cl. 430/124.32; 399/335

(57) ABSTRACT

A surface temperature of a heat regulated printer element is accurately controlled by providing at least a layer of a rubber material with a phase change material dispersed therein. A method of printing uses an image receiving intermediate carrier including at least a layer of a rubber material with a phase change material dispersed therein.

### CROSS-REFERENCE TO RELATED APPLICATIONS

This application claims priority under 35 U.S.C. § 119(a) to Application No. 08151162.8, filed in Europe on Feb. 7, 2008, the entirety of which is expressly incorporated herein by reference.

### BACKGROUND OF THE INVENTION

1. Field of the Invention

The present invention relates to a heat regulated printer element and a printer comprising at least one heat regulated printer element. The present invention also relates to a method of heat control by using at least one layer of a rubber material having a phase change material dispersed therein. The present invention further relates to a method of printing, using an image receiving intermediate carrier or a fuse roller comprising at least one layer of a rubber material having a phase change material dispersed therein.

2. Description of Background Art

A heat regulated printer element, which may be an image receiving intermediate carrier, is well known in the art of printing. In conventional electrographic printing processes, a latent (electrostatic) image is formed on a primary image carrier (e.g. photoconductor, direct imaging means). The latent image is then developed by bringing a toner powder into contact with the primary image carrier. Electrostatic forces cause toner particles to selectively adhere to the surface of the latent image carrier, thus forming a toner image on the primary image carrier. Subsequently, the toner image is transferred to an image receiving intermediate carrier, in order to prevent direct contact between the final image carrier (e.g. paper) and the primary image carrier, and thus preventing or at least diminishing fouling (e.g. contamination with paper dust particles) of the primary image carrier. An image receiving intermediate carrier comprises, e.g. an endless belt or a drum.

Conventional image receiving intermediate carriers may comprise a rubber top-layer with such properties that the image receiving intermediate carrier may be capable of picking up the toner image from the primary image carrier and subsequently releasing the toner image in the transfer nip, in order to transfer the image to the final image carrier. Finally, the toner image may be fused on the final image carrier. Transferring the image to the final image carrier and fusing the image thereon may be combined in a single step, e.g. a transfuse step.

Full color printing requires several primary image carriers, each carrying a partial image of a different color (e.g. four: Cyan, Magenta, Yellow and Black: CMYK; possibly more to, e.g. increase color gamut). Accurate registering of all partial images is necessary in order to obtain an acceptable print quality.

Recent developments show that ink-jet methods, in particular hot-melt inkjet printing offer great opportunities for high speed and very high speed full color printing. Several steps in the conventional electrographic printing methods can be omitted, e.g. the partial images can be substantially simultaneously printed on an image recording medium.

Hot-melt ink, also referred to as ‘phase change ink,’ may, of course, be directly printed on the final image receiving material. To increase the dot gain, the final image receiving material may be subjected to a fuse step after an image has been printed. However, due to irregularities in the surface of the final image receiving material (i.e. surface roughness of, e.g. a sheet of paper), the ink dots may spread unevenly, leading to an unsatisfactory print quality. This effect may be prohibited or at least mitigated by first printing on an image receiving intermediate carrier, which image receiving intermediate carrier may have a well defined surface, followed by transfer and fuse steps. The substantially spherical ink drops (i.e. slightly flattened ink drops due to the impact on the surface of the image receiving intermediate carrier) printed on the image receiving intermediate carrier are (further) flattened during transfer and fuse under pressure on the final image carrier.

Hot-melt ink drops may be jetted through nozzles provided in the hot-melt ink printhead. The drops are jetted at elevated temperatures where the hot-melt ink is in a melted state. On the flight to the image receiving intermediate carrier, the drops may cool down, such that upon impact on the image receiving intermediate carrier the ink drops may be in a malleable state, but still at an elevated temperature.

Dependent on the local surface coverage of the image receiving intermediate carrier with the ink, the amount of received thermal energy per unit of surface area on the image receiving intermediate carrier may vary within the printed image, bringing about a variation in the local surface temperature of the image receiving intermediate carrier.

Conventional image receiving intermediate carriers have the disadvantage that the materials used, in particular for the top-layer, are incapable of levelling the surface temperature of the image receiving intermediate carrier within an acceptable range within an acceptable time-frame. Therefore, the temperature variations within the image may remain, which may lead to a variation in transfer efficiency across the printed image. If the surface temperature of the receiving intermediate carrier is too high, the ink viscosity is too low. As a result, the cohesion forces in an ink drop may become smaller than the adhesion forces between the ink drop and the image receiving intermediate carrier, which may prevent complete transfer of the ink drop to the final image receiving carrier. Therefore, the image tends to split. However, if the surface temperature of the receiving intermediate carrier is too low, the image may not transfer at all, because ink drops have solidified to such an extent that wetting of the surface of the final image receiving carrier and absorption of the ink in the surface of the final image receiving carrier is hindered.

Hence, a poor levelling of the surface temperature of an image receiving intermediate carrier may cause parts of an image to split (i.e. high OD image parts, e.g. photographs) and other parts to not transfer at all (i.e. low OD image parts, e.g. text-areas).

A heat regulated printer element, which is an image drum for use in an indirect inkjet printing process is known from U.S. Patent Application Publication No. 200710024687. The image drum comprises an operational fluid, arranged between a first cylindrical body and a heat generator. When the drum is heated, the surface temperature of the image drum can be precisely and uniformly controlled. The power consumption decreases and heat is efficiently transmitted.

The image drum disclosed in U.S. Application No. 2007/0024687 has been designed for effectively transmitting heat provided by a heat generator to the surface of the image drum. When the desired surface temperature has been reached, the heat generator may be switched off. The operational fluid may absorb the remaining heat coming from the heat generator by evaporation and thus prevents overshoot of the surface temperature of the image drum.

The image drum described in the above mentioned patent application has a rather complex configuration comprising a gas-tight outer cylindrical body with a heat generator inside. An operational fluid is present between the outer cylindrical body and the heat generator. The operational fluid contacts the inner surface of the outer cylindrical body and transmits heat from the heat generator to only a part of the outer cylindrical body. The image drum needs to be continuously rotated to obtain a uniform surface temperature.

### SUMMARY OF THE INVENTION

It is an object of the present invention to provide a heat regulated printer element with a simpler configuration, while at least maintaining, but preferably improving the ability of controlling the surface temperature. This object is achieved by providing a heat regulated printer element that comprises at least one layer of a rubber material having a phase change material dispersed therein, said at least one layer of rubber material being arranged for heat regulation.

The rubber material having a phase change material dispersed therein is provided to increase the heat capacity of the heat regulated printer element.

The heat regulated printer element may, for example be an image receiving intermediate carrier or a fuse roller.

Due to the increased heat capacity, relatively large amounts of heat may be exchanged between printed ink drops and an image receiving intermediate carrier, without significantly changing the surface temperature. As a result, the surface temperature of an image receiving intermediate carrier remains substantially constant during printing, regardless of the local surface coverage with ink. Hence, the earlier described variation in surface temperature is reduced. Furthermore, the heat that is stored in an image receiving intermediate carrier in the above described way, may maintain the surface temperature at a substantially constant level, even after transferring the image to the receiving material.

The heat regulated printer element according to the present invention has the advantage that heat regulation is enabled in a very locally precise way, which means that, for example at the location on the surface of an image receiving intermediate carrier according to the present invention where a hot ink drop may land, the excess heat carried by the printed ink drop may be directly and substantially instantly transmitted to the locally dispersed phase change material, which may absorb the heat without substantially increasing in temperature.

In an embodiment, a phase change material used in a rubber material is in a micro-encapsulated form. This embodiment has the advantage that the phase change material does not diffuse through the rubber matrix. An additional advantage is that the mechanical properties of the rubber material are not, or at most to a very minor extent, affected by the phase change material, particularly at elevated temperatures.

In an embodiment, the heat regulated printer element comprises an image receiving intermediate carrier (comprising, e.g. an endless belt, drum, or the like) which is provided with at least one layer of a rubber material with a phase change material dispersed therein. Phase change materials have a relatively high heat of fusion (e.g. melting heat, crystallization heat). Therefore, a phase change material may be used as a heat regulation device according to the present invention, if during printing of warm ink, the local surface temperature of the image receiving intermediate carrier reaches the phase change temperature (e.g. melting temperature, crystallization temperature) of the phase change material. When the relatively warm hot-melt ink is printed on the image receiving intermediate carrier, heat exchange between the warm ink drops and the phase change material in the image receiving intermediate carrier occurs. When the phase change material reaches the phase change temperature, the phase change material continues to absorb thermal energy of printed ink drops at a constant temperature (e.g. melting temperature, crystallization temperature). Heat exchange at this constant temperature can take place until the phase change (e.g. melting, crystallization) is complete. The stored heat may be released to maintain the surface temperature and the printed hot-melt ink at elevated temperatures for a substantial amount of time.

The present invention also relates to a method of heat control, wherein at least one layer of a rubber material having a phase change material dispersed therein is provided in a heat regulated printer element, and said at least one layer of rubber material is arranged for heat regulation.

In an embodiment, the present invention provides a printer comprising at least one heat regulated printer element.

In another aspect, the present invention provides a method of printing with a hot-melt ink imaging device (also referred to as hot-melt ink printhead) on an image receiving intermediate carrier comprising a rubber material having a phase change material dispersed therein. The method comprises printing an image on the intermediate image carrier with a hot-melt ink imaging device and transferring the printed image from the intermediate image carrier to a final image carrier.

In an embodiment, the present invention provides a method of printing, using a fuse roller comprising a rubber material having a phase change material dispersed therein. The method comprises providing heat to the fuse roller and fusing the transferred image on the final image carrier (e.g. a sheet of paper).

In an embodiment, a method of indirect printing further comprises recharging a heat regulation device by heating with a heater.

In an embodiment, a method of indirect printing further comprises discharging a heat regulation device by cooling with a cooling device, e.g. a fan.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic representation of an image receiving intermediate drum with a hot-melt ink imaging device and a transfer nip;

FIG. 2a is a schematic representation of an image receiving intermediate belt with a hot-melt ink imaging device and a transfer nip;

FIG. 2b is a schematic enlarged representation of a part of the image receiving intermediate belt;

FIG. 3 is a thermogram of a hot-melt ink;

FIG. 4 is a graph of a schematic representation of a temperature range in which a hot-melt ink may be pressure transferable;

FIG. 5 is a graphical representation of a temperature operating window of an image receiving intermediate carrier with a hot-melt ink as a function of the temperature of a final image receiving medium (e.g. a sheet of paper); and

FIG. 6 is a schematic representation of an image comprising two partial images on a sheet of a final receiving medium (e.g. a sheet of paper).

### DETAILED DESCRIPTION OF THE PREFERRED EMBODIMENTS

The present invention will now be described with reference to the accompanying drawings, wherein the same reference numerals have been used to identify the same or similar elements throughout the several views.

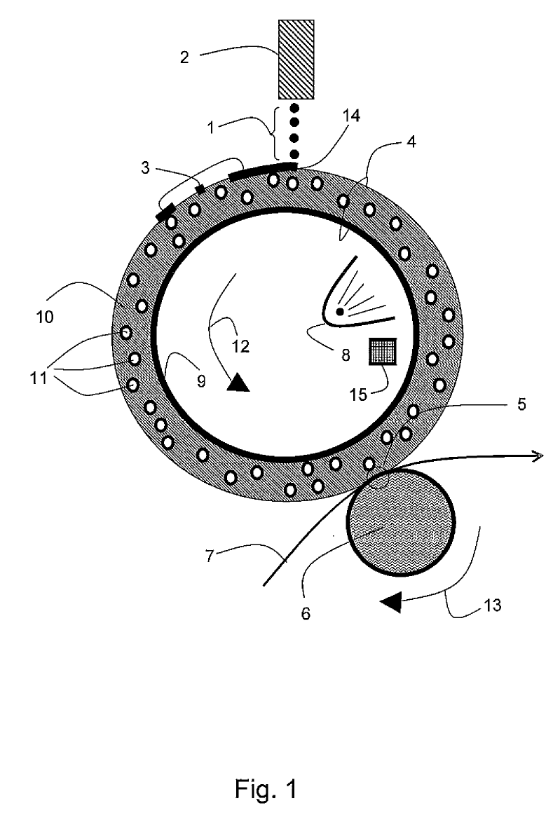

FIG. 1 schematically represents the principle of printing hot-melt ink on an image receiving intermediate carrier 4, which in this embodiment may be a drum, comprising a rubber layer 10, 11 according to the present invention. FIG. 1 further shows the path of the printed image 3 to a transfer nip 5 and the path of the final image carrier 7 (e.g. a sheet of paper) through the transfer nip 5.

The image receiving intermediate carrier 4 comprises a support member (drum) 9, which in this embodiment may be a support drum and at least a layer of a rubber material 10 with a micro-encapsulated phase change material 11 dispersed therein. The support drum comprises, e.g. an aluminium or a glass cylinder. The micro-encapsulated material has such properties that the composite rubber top-layer may act as a heat sink, which enables levelling of the surface temperature of the image receiving intermediate carrier, even if the surface coverage with ink varies to a large extent within a single image.

Hot-melt ink drops 1 may be jetted from an imaging device 2 (also referred to as a hot-melt ink printhead) onto a portion of the outer surface of the image receiving intermediate carrier 4, referred to as a printing zone 14. An image 3 may be printed on the image receiving intermediate carrier 4, and transported to the transfer nip 5, by rotating the image receiving intermediate carrier 4 counter-clockwise as indicated by arrow 12 inside the image receiving intermediate carrier 4. The transfer nip 5 may be formed by the image receiving intermediate drum and a transfer roller 6, the latter may be co-rotating in a clockwise direction, as indicated by arrow 13. The transfer roller 6 may be arranged such that it can be pressed against the image receiving intermediate carrier 4. In the transfer nip 5, an image 3 may be transferred under pressure to a final image carrier 7, for example a sheet of paper. After transferring an image to a final image carrier 7, the image may be fused to the final image carrier 7. An image 3 may also be fused in a transfer nip 5, which process step is then referred to as a transfuse step.

An optional cooling device 15 may be positioned downstream of the transfer nip 5 for releasing heat stored in the top layer of the image receiving intermediate carrier 4, in order to provide sufficient heat storage capacity for a subsequent printing cycle.

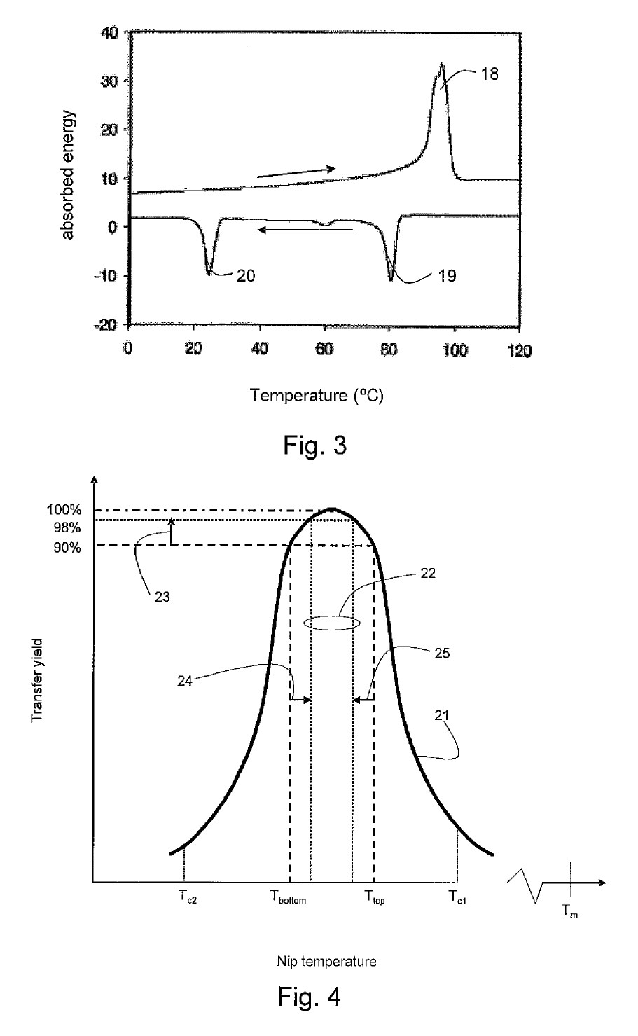

A heater 8 may be positioned downstream of the transfer nip 5 for heating the image receiving intermediate carrier 4 to a predetermined temperature, before a fresh image is printed on the outer surface of the image receiving intermediate carrier 4. The surface of the image receiving intermediate carrier 4 may need to be heated, for example if the surface temperature has dropped below a predetermined lower temperature below which efficient image transfer is no longer possible. The criteria determining whether or not an inlc is pressure transferable are explained in the descriptions of FIG. 3 and FIG. 4, hereinafter.

An imaging device 2 may comprise a scanning carriage comprising several printheads, each arranged for printing a partial monochrome image (e.g. Cyan, Magenta, Yellow or Black: CMYK) in order to create a full color image on the image receiving intermediate carrier 4. A complete full color image may be printed during several complete revolutions of the image receiving intermediate carrier 4. If a complete image is printed during several complete revolutions of the image receiving intermediate carrier 4, the transfer roller 6 may be arranged such that direct contact between the fuse roller and the (partial) printed image may be prevented. When a complete image has been printed, the transfer roller 6 may be pressed against the image receiving intermediate carrier 4; paper may be transported to the transfer nip 5 and the printed image may be transferred to a final image carrier 7, for example a sheet of paper.

Another type of imaging device 2 may be a page wide high resolution printhead comprising all necessary colors (CMYK) to print a full color image, e.g. a MEMS printhead. This kind of printhead may require only one revolution for a complete printing cycle. In this case, the transfer roller 6 may be arranged such that it is continuously pressed against the image receiving intermediate carrier 4.

The possible print strategies and patterns are numerous. Also hybrid forms of the above-described configurations may be possible variations of embodiments according to the present invention.

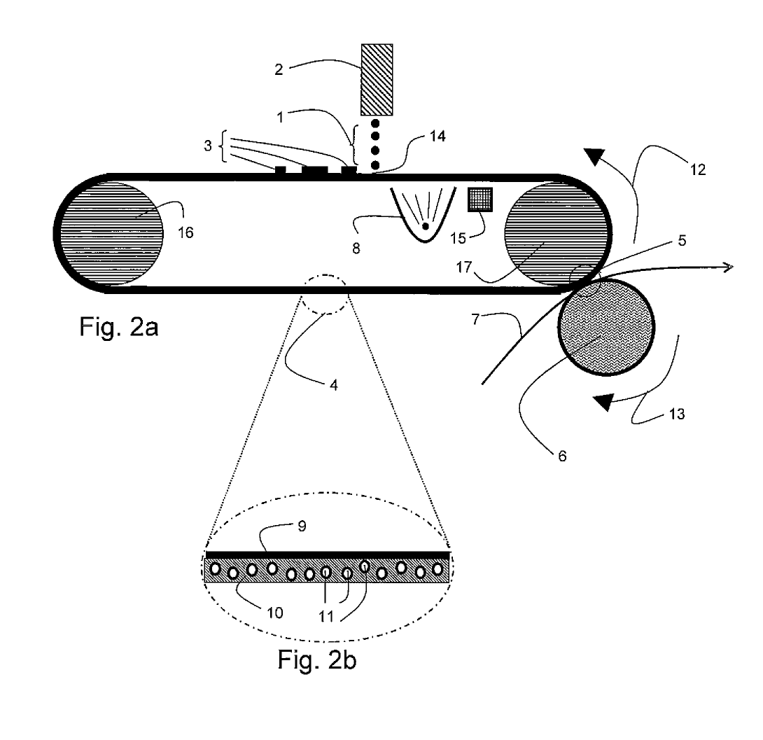

FIG. 2a schematically represents the principle of printing hot-melt ink on an image receiving intermediate carrier 4, which in this embodiment may be an endless belt, comprising a composite rubber layer 10, 11 according to the present invention. FIG. 2a further shows the path of the printed image 3 to a transfer nip 5 and the path of the final image carrier 7 through the transfer nip 5. The reference numerals in FIG. 2 correspond to similar parts as previously described in FIG. 1. The printing process is comparable to the printing process as explained in the description of FIG. 1. Detailed description thereof is therefore omitted.

The image receiving intermediate carrier 4 comprises two supporting rollers 16, 17. FIG. 2b is a schematic enlarged representation of a part of the image receiving intermediate carrier 4, which in this embodiment is an endless belt comprising a support member 9. The support member 9 may be a support layer, which may be, but is not limited to, a woven or non woven fabric, a rubber sheet material, or the like. The endless belt further comprises at least a layer of a rubber material 10 with a micro-encapsulated phase change material 11 dispersed therein.

FIG. 3 shows a thermogram of a hot-melt ink comprising an amorphous binder (approximately 25%) and a first and a second crystalline diluent (each approximately 37.5%), which thermogram may be recorded using a differential scanning calorimeter, for example the Perkin Elmer DSC-7 apparatus. On heating from the solid state (both crystalline diluents are crystallized), the ink has one (compound) melting peak 18 at approximately 95° C. On cooling from the melting temperature (i.e. starting at a temperature above the melting temperature, in this case above approximately 95° C.), the first crystalline diluent may crystallize at approximately 80° C., represented by a peak 19, while the second crystalline diluent does not crystallize until approximately 25° C. represented by a peak 20. This means that within a temperature range of approximately 25° C. to approximately 80° C. the ink may be in a transition state between the melted state and the solid state. Within the above-described temperature range lies the so-called gelled state, wherein the ink is neither solid nor liquid, but in a malleable state.

FIG. 4 schematically shows a curve 21, which represents a transfer yield (also referred to as transfer efficiency) as a function of the temperature in the transfer nip, of a hot-melt ink that is pressure transferable. The determination of whether or not a hot-melt ink is pressure transferable is described in European Patent Application Nos. 1 378 551 and 1 950 259, which are hereby incorporated by reference. FIG. 4 shows a lower temperature, T_{bottom} and an upper temperature, Tₜₒₚ, between which temperatures the printed image transfers from the image receiving intermediate carrier to the final image carrier with a transfer yield of at least 90%. It may be obvious that in practice higher transfer yields are preferred, for example at least 98%. A melting temperature (Tₘ), a first crystallization temperature (T_{C1}; corresponding to the crystallization temperature of the first crystalline diluent, which is approximately 80° C. as is shown in FIG. 3) and a second crystallization temperature (T_{C2}; corresponding to the crystallization temperature of the second crystalline diluent, which is approximately 25° C. as is shown in FIG. 3).

To realize a transfer yield higher than 90% of the ink in a printing process as previously described and shown in FIG. 1 and FIG. 2, for example a transfer yield of 98%, the temperature working range narrows down as indicated by the dotted lines 22 and arrows 23, 24 and 25 in FIG. 4. This implies that the temperature in the transfer nip may be very critical concerning the transfer yield.

In practice, the lower temperature in the transfer nip may be determined by the temperature at which the transferred image cannot be damaged or smeared by friction or pressure, scratching or folding: the so called gum, scratch, fold (GKV) resistance. This practical lower temperature, T′_{bottom} (not shown) appears to be only a few degrees Celcius above the lower temperature (T_{bottom}) of the pressure transfer working range.

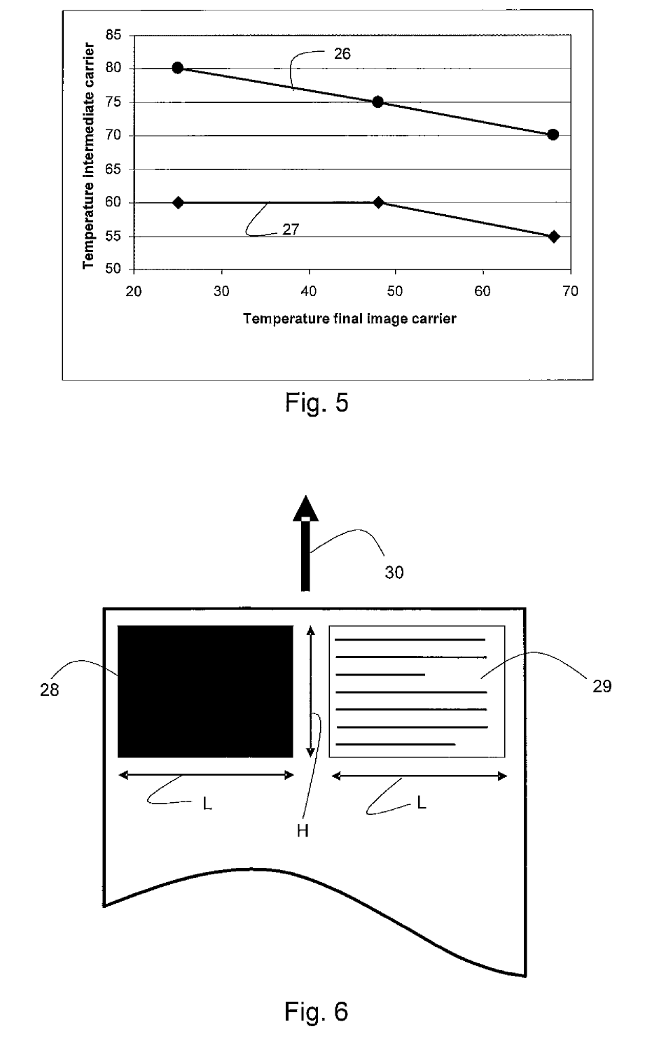

FIG. 5 schematically shows a practically determined temperature working range of an image receiving intermediate carrier on which a hot-melt ink may be printed as a function of the temperature of the final image receiving medium. A first line 26 indicates an upper limit of a working range of an image receiving intermediate carrier, which limit may be a temperature at which substantially no ink-dot-split occurs during a transfer of an image from an image receiving intermediate carrier to a final image carrier. A second line 27 indicates a lower limit of a working range of an image receiving intermediate carrier, which limit may be a temperature at which ink dots may be sufficiently well transferred or transfused from an image receiving intermediate carrier to a final image carrier, such that an acceptable gum-scratch-fold resistance (GKV) may be obtained. FIG. 5 shows that the temperature of a final image receiving medium only has a minor influence on the width of the working range, which working range covers approximately 15° C. to 20° C.

It is noted that the working range described in relation to FIG. 5 refers to the temperature range of the image receiving intermediate carrier, whereas the previously described working range refers to the temperature limits between which a hot-melt ink may be pressure transferable (i.e. T′_{bottom} and Tₜₒₚ), which is the desired temperature range in the nip. The relationship between a nip temperature range, the temperature range of an image receiving intermediate carrier and the temperature of a final image carrier will be shown later.

FIG. 6 shows an example of a sheet of a final receiving medium (e.g. a sheet of paper) with an image comprising a first area with a high surface coverage with ink 28, e.g. a photographic partial image, and a second area with a low surface coverage with ink 29, e.g. a partial image comprising a column of text. In this embodiment, the first area and the second area are equal in size (L×H) and are arranged such that the first area and the second area may simultaneously pass through the transfer nip. Arrow 30 indicates the transport direction of the final image carrier, which direction may be comparable to the transport direction indicated with number 7 in FIG. 1 and FIG. 2. The average surface coverage with ink of the second area 29 may be 10% or less compared to the average surface coverage of the first area 28.

An image as shown in FIG. 6 may first be printed on an image receiving intermediate carrier, before the image may be transferred to the final image carrier in the transfer nip. An image may be printed on an image receiving intermediate carrier by ejecting ink drops from a hot-melt inkjet printhead, as previously described. The image receiving intermediate carrier may be rotated and the printhead may be moved such that the ink drops are received by the image receiving intermediate carrier in a pattern of dots, which dots build up the image.

The ejected ink drops are in a melted state when they leave the printhead and cool down during the flight to the printing zone 14, to a temperature Tᵢₙₖ, which temperature may be the same or different for individual ink drops. To prevent excessive spreading and running of an ink drop on the image receiving intermediate carrier, the ink drop needs to be cooled down to a temperature which is below the crystallization temperature of a first crystalline component (T_{C1}) in a hot-melt ink composition (see FIG. 3 and FIG. 4.). In general, the initial surface temperature (T_{surface, initial}, i.e. the surface temperature of the image receiving intermediate carrier before an image has been printed thereon) of the image receiving intermediate carrier is controlled such that the nip temperature (Tₙᵢₚ) lies within the pressure transferable range (i.e. T′_{bottom} and Tₜₒₚ, FIG. 4).

An ink drop may release heat due to the possible subsequent steps: a) cooling of an ink drop from the temperature at impact on the image receiving intermediate carrier (Tᵢₙₖ) to the crystallization temperature of the first crystalline diluent (T_{C1}); b) crystallization of the first crystalline component (heat of crystallization: ΔH_{C1}) in a hot-melt ink drop; and c) cooling from the crystallization temperature of the first crystalline component (T_{C1}) to the final surface temperature (T_{surface, final}).

In general the crystallization heat of the first crystalline diluent (ΔH_{C1}) may be the largest contribution in the total amount of thermal energy that may be released by a hot-melt ink drop.

In case the surface of an image receiving intermediate carrier is provided with a conventional top-layer, without the ability of levelling the surface temperature, the surface of the image receiving intermediate carrier may heat up unevenly if an image, as shown in FIG. 6, may be printed on the surface of the image receiving intermediate carrier. The amount of ink printed on an image receiving intermediate carrier to obtain a partial image according to a partial image in the first area 28 of FIG. 6 may be ten times as large as the amount of ink printed to obtain a partial image according to the partial image in the second area 29 of FIG. 6. Therefore, the total amount of thermal energy released by the hot-melt ink (Qᵢₙₖ) in the first area 28 may be approximately ten times larger than the total thermal energy released in the second area 29. With a constant heat capacity (C_{surface}) across the surface of the image receiving intermediate carrier, the temperature rise of the surface of the image receiving intermediate carrier (ΔT_{surface}) in the first area 28 may be approximately ten times larger than the temperature rise in the second area 29:

Qᵢₙₖ=C_{surface}*ΔT_{surface} Equation 1

Q_{ink, first area}≈10*Q_{ink, second area} Equation 2

ΔT_{surface, final first area}≈10*ΔT_{surface, final second area} Equation 3

ΔT_{surface}=T_{surface, final}−T_{surface, initial} Equation 4

The printing speed may be such that no further cooling of the ink drops on the image receiving intermediate carrier occurs.

The difference in surface temperature of the image receiving intermediate carrier between the first area 28 and the second area 29 may be expressed as:

ΔT_{surface, first area-second area}=T_{surface, final first area}−T_{surface, final second area} Equation 5

With Equation 3 and Equation 4, Equation 5 can be rewritten as:

ΔT_{surface, first area-second area}=0.9*ΔT_{surface, final first area} Equation 6

It has been found that the temperature difference between the first area and the second area on the surface of the image receiving intermediate carrier (ΔT_{surface, first area-second area}) may be as large as 20° C. or even larger. Comparing this to the practical temperature working range shown in FIG. 5, it can be concluded that there may be a substantial difference between the transfer yields of the partial image in the first area 28 of FIG. 6 and the partial image in the second area 29 of FIG. 6, if an image receiving intermediate carrier with a conventional top-layer is used in an indirect printing process.

In case an image receiving intermediate medium is provided with a top-layer according to the present invention, a phase change material will absorb substantially all thermal energy released by the ink drops (e.g. heat of cooling of the ink drops, the crystallization heat of the first crystalline diluent). When the surface temperature of the image receiving intermediate carrier reaches the phase change temperature (e.g. melting temperature, crystallization temperature or the like) of the phase change material, the surface temperature remains constant until the total amount of phase change material present in the top-layer directly located underneath the printed area has undergone a phase change (e.g. melting, crystallization or the like). The surface of the image receiving intermediate carrier maintains a substantially constant temperature, which is substantially equal to the phase change temperature of the phase change material. The nip temperature can be easily controlled within a small temperature range, which is in favor of the transfer yield of the entire image, regardless of the differences in surface coverage with ink (e.g. images as shown in FIG. 6).

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A heat regulated printer element comprising:
at least one layer of a rubber material having a phase change material dispersed therein, said at least one layer of rubber material being arranged for heat regulation.

2. The heat regulated printer element according to claim 1, wherein the phase change material is in a micro-encapsulated form.

3. The heat regulated printer element according to claim 1, wherein the heat regulated printer element comprises an image receiving intermediate carrier.

4. The heat regulated printer element according to claim 3, wherein the image receiving intermediate carrier comprises an endless belt, the belt comprising said rubber material arranged for heat regulation.

5. The heat regulated printer element according to claim 3, wherein the image receiving intermediate carrier comprises a drum, said rubber material being arranged on an outer surface of the drum for heat regulation.

6. The heat regulated printer element according to claim 1, wherein the heat regulated printer element is a fuse roller, said rubber material being arranged on an outer surface of the fuse roller for heat regulation.

7. A method of heat regulation, comprising the steps of:
providing at least one layer of a rubber material having a phase change material dispersed therein in a heat regulated printer element, said at least one layer of rubber material being arranged for heat regulation.

8. The method of heat regulation according to claim 7, further comprising the step of providing the phase change material in a micro-encapsulated form.

9. A printer comprising
at least one heat regulated printer element comprising at least one layer of a rubber material having a phase change material dispersed therein, said at least one layer of rubber material being arranged for heat regulation.

10. The printer according to claim 9, wherein the phase change material is in a micro-encapsulated form.

11. The printer according to claim 9, wherein the heat regulated printer element comprises an image receiving intermediate carrier.

12. The printer according to claim 11, wherein the image receiving intermediate carrier comprises an endless belt, the belt comprising said rubber material arranged for heat regulation.

13. The printer according to claim 11, wherein the image receiving intermediate carrier comprises a drum, said rubber material being arranged on an outer surface of the drum for heat regulation.

14. The printer according to claim 9, wherein the heat regulated printer element is a fuse roller, said rubber material being arranged on an outer surface of the fuse roller for heat regulation.

15. A method of printing, comprising the steps of:
providing an image receiving intermediate carrier comprising at least one layer of a rubber material having a phase change material dispersed therein, said at least one layer of rubber material being arranged for heat regulation;
printing an image on the image receiving intermediate carrier with a hot-melt ink imaging device; and
transferring the printed image from the image receiving intermediate carrier to a final image carrier.

16. The method of printing according to claim 15, further comprising the step of fusing the transferred image on the final image carrier.

17. The method of printing according to claim 15, further comprising the step of recharging the image receiving intermediate carrier by heating the image receiving intermediate carrier with a heater.

18. The method of printing according to claim 15, further comprising the step of discharging the image receiving intermediate carrier by cooling the image receiving intermediate carrier with a cooling device.

19. A method of printing, comprising the steps of:
providing a fuse roller comprising at least one layer of a rubber material having a phase change material dispersed therein, said at least one layer of rubber material being arranged for heat regulation;
providing heat to the fuse roller; and
fusing the transferred image on the final image carrier.

20. The method of printing according to claim 19, further comprising the step of recharging the fuse roller by heating the fuse roller with a heater.

21. The method of printing according to claim 19, further comprising the step of discharging the fuse roller by cooling the fuse roller with a cooling device.
